(19) United States
(12) Patent Application Publication
(10) Pub. No.: US 2009/0073545 A1
(43) Pub. Date: Mar. 19, 2009

(54) DISPLAY APPARATUS USING MONITORING LIGHT SOURCE

(75) Inventor: In-Jae Yeo, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon, (KR)

(21) Appl. No.: 12/208,309

(22) Filed: Sep. 10, 2008

(30) Foreign Application Priority Data
Sep. 19, 2007 (KR) 10-2007-0095223

(51) Int. Cl. G02F 1/29

(52) U.S. Cl. 359/315

(57) ABSTRACT

A display apparatus using monitoring light source is disclosed. a display apparatus includes a display light source of emitting a display beam, a monitoring light source of emitting a monitoring beam, an optical modulator of modulating the display beam and the monitoring beam to output a diffracted display beam and a diffracted monitoring beam, a scanner of scanning the diffracted display beam onto a display screen, an optical detector of receiving the diffracted monitoring beam and producing a detection signal corresponding to a quantity of light of the diffracted monitoring beam, and a controller of producing a control signal for controlling the optical signal according to an image signal, deciding a compensation value on receiving the detection signal, and producing a control signal to where that the compensation value is applied when modulating the display beam. Variation in displacement of each micro-mirror can be compensated by using a monitoring light source.

### CROSS-REFERENCE TO RELATED APPLICATION

This application claims the benefit of Korean Patent Application No. 10-2007-0095223, filed with the Korean Intellectual Property Office on Sep. 19, 2007, the disclosure of which is incorporated herein by reference in its entirety.

### BACKGROUND OF THE INVENTION

1. Field of the Invention

The present invention relates to an optical modulator and more particularly, to method of compensating a variation in a drive displacement of the optical modulator and display apparatus adapting this.

2. Related Art

Generally, unlike the conventional digital data processing that could not process a large quantity of data and in real time, a light signal processing is advantageous in high-speed, parallel and large quantity of data processing, and by using a spatial optical modulation theory, researches on a design and implementation of binary phase filter, an optical logic gate, an optical amplifier, etc., are undertaken. Among these, the optical modulator is applied to various fields such as an optical memory, optical display, printer, optical interconnection, holography, etc, and a research and development of optical beam scanning device has progressed.

This optical beam scanning device in, for example, a laser printer, a LED printer, an electronic picture copier, a word processor, or a projector, scans the optical beam and spots the optical beam on a photosensitive material for an object to be image on it.

Recently, with the development of projection-type television, the optical beam scan device is used to scan beam to an image display.

The optical modulator that is used in a scanning display device, which is one of display, includes a driving circuit and a plurality of micro mirrors. More than one of micro mirror represents one pixel of the projected image.

In order to represent light intensity of a pixel, the micro-mirror changes a quantity of light of modulated light by changing its displacement in response to a driving signal (e.g., drive voltage) supplied by the driving circuit. The driving circuit generates the driving signal having a certain relationship to an input signal. And the quantity of light of modulated light has non-linear relationship to the driving signal.

Drive displacement of micro-mirror for each pixel has a variation due to problems happened during manufacturing, driving hysteresis effect caused by long term of use, etc. Due to this variation of reference displacement of micro-mirror, even if same voltage is applied to more than two different pixels, quantity of light of modulated light of each pixel is different from each other. Accordingly, there are problems that uneven image is reproduced and image quality is deteriorated.

### SUMMARY OF THE INVENTION

The present invention provides a method of compensating variation in displacement of each micro-mirror by using a monitoring light source and display apparatus using it.

According to one aspect of the present invention, there is provided a display apparatus, includes a display light source of emitting a display beam, a monitoring light source of emitting a monitoring beam, an optical modulator of modulating the display beam and the monitoring beam to output a diffracted display beam and a diffracted monitoring beam, a scanner of scanning the diffracted display beam onto a display screen, an optical detector of receiving the diffracted monitoring beam and producing a detection signal corresponding to a quantity of light of the diffracted monitoring beam, and a controller of producing a control signal for controlling the optical signal according to an image signal, deciding a compensation value on receiving the detection signal, and producing a control signal to where that the compensation value is applied when modulating the display beam.

The monitoring beam may have a wavelength different from display beam.

Or the monitoring beam may have a wavelength out of visible ray, and it may be is an infrared

The optical detector may include a photo detector, or a plurality of unit sensors.

The optical modulator produces a n^{th} order diffracted beam (n is equal to or greater than 0) and receives an a^{th} order diffracted beam of the diffracted monitoring beam, and the scanner receives a b^{th} order diffracted beam of the diffracted display beam. Where, a and b are integer.

The apparatus may further include a wavelength selection filter that locates on a beam path of the diffracted monitoring beam and passes the diffracted monitoring beam, and the optical detector arranges the wavelength selection filter at a location corresponding to a beam path of the diffracted monitoring beam.

The optical modulator produces n^{th} order diffracted beams (n is natural number), and the optical modulator further includes an imaging optical system of progressing one diffracted beam among n^{th} order diffracted beams from the optical modulator to the scanner, and a spatial separation filter of being located between the imaging optical system and the scanner, blocking the diffracted monitoring beam, and passing the diffracted display beam. The spatial separation filter comprises a hole being formed on location corresponding to a beam path of the diffracted display beam. The spatial separation filter comprises a mirror at a location corresponding to a beam path of the diffracted monitoring beam so changes the beam path of the diffracted monitoring beam to be entered into the optical detector. The spatial separation filter arranges the optical detector at a location corresponding to a beam path of the diffracted monitoring beam.

The controller controls the monitoring light source and the display light source time-divisionally.

Additional aspects and advantages of the present general inventive concept will be set forth in part in the description which follows, and in part will be obvious from the description, or may be learned by practice of the general inventive concept.

### BRIEF DESCRIPTION OF DRAWINGS

FIG. 1 shows the display device using linear optical modulator;

FIG. 2 shows a micro-mirror in optical modulator with open hole structure;

FIG. 3 is a plan view of an optical modulator containing a plurality of micro-mirrors illustrated in FIG. 2;

FIG. 4 is a perspective view of the optical modulator containing micro-mirrors illustrated in FIG. 2;

FIG. 5 shows a relation graph of voltage being applied to the optical modulator, the displacement of each micro-mirror therefore, and intensity (i.e., quantity of light) of modulated light;

FIG. 6 shows the displacement variation of micro-mirror responsible for each pixel;

FIG. 7 shows a display apparatus using the monitoring light source according to one embodiment of the present invention;

FIG. 8 shows a display apparatus using a monitoring light source according to another embodiment of the present invention;

FIG. 9 shows a display apparatus using a monitoring light source according to still another embodiment of the present invention;

FIG. 10 shows a relation graph of voltage being applied to the optical modulator, the displacement of each micro-mirror therefore, and intensity (i.e., quantity of light) of modulated light according to one embodiment of the present invention;

FIG. 11 shows an output timing of drive signal for measuring variation of displacement of micro-mirror in case of time-divisionally controlling;

FIG. 12 shows a circuit diagram of optical detector according to one embodiment of the present invention; and

FIG. 13 illustrates the quantity of light of measured diffracted monitoring beam.

### DETAILED DESCRIPTION OF CERTAIN INVENTIVE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

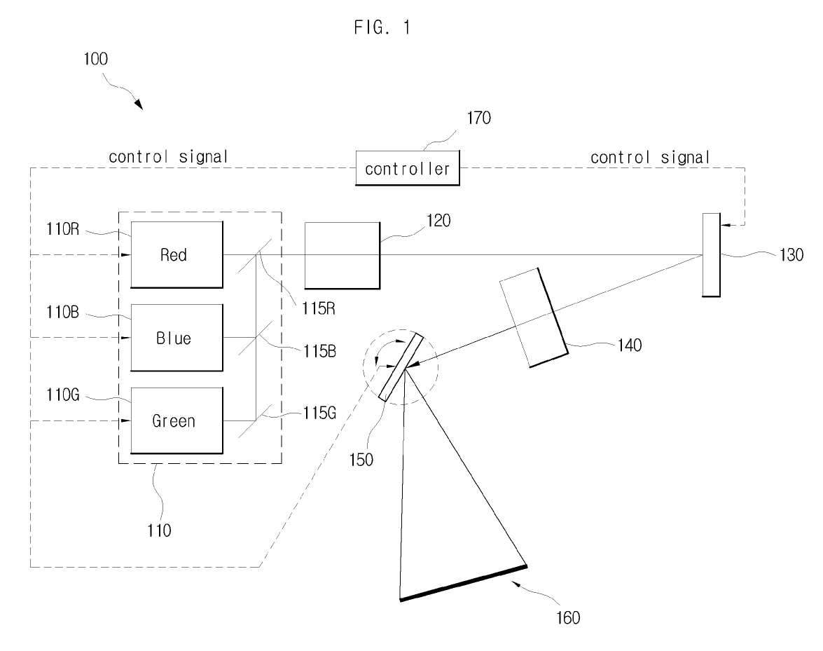

Display scheme of a display device using a linear optical modulator will be described with reference to FIG. 1. FIG. 1 shows the display device using linear optical modulator. Display device 100, display light source 110, red light source 110R, blue light source 110B, green light source 110G, mirror 115G, the first dichroic mirror 115R, the second dichroic mirror 115B, illumination optical system 120, optical modulator 130, imaging optical system 140, scanner 150, display screen 160, and a controller 170 are shown.

The display light source 110 emits a beam. The display light source 110 may be one of laser, LED, and laser diode.

In one embodiment, the display light source 110 emits a white beam. In this case, a color splitter (not shown) splits under a certain condition the white beam into a red beam, a green beam, and a blue beam.

In another embodiment, the display light source 110 includes, as shown in FIG. 1, the red light source 110R, the blue light source 110B, the green light source 110G, and emits the red beam, green beam, and blue beam, i.e., the three primary colors of light. Red, green, and blue beams are mere one embodiment therefore it will be possible for other combination of colored beams if the combination can represent various colors.

In the above mentioned embodiment, although displaying a colored image on the display screen 160 is described, however, it is also possible for the display light source to emit a monochromatic beam and a monochromatic image will be displayed on the display screen 160.

The illumination optical system 120 locates between the display light source 110 and the optical modulator 130. The illumination optical system 120 adjusts the direction of beam emitted from the display light source 110 to focus the beam onto the optical modulator 130.

In case that the display light source 110 included the red light source 110R, the blue light source 110B, and the green light source 110G as shown, in order for the colored beams from each light source to be entered into the illumination optical system 120, the mirror 115G for changing a beam path and the dichroic mirrors 115R, 115B for reflecting light having a certain wavelength and passing light having other wavelength are located at the end of each color light source.

The mirror as shown in FIG. 1 reflects the green beam at a certain angle, the first dichroic mirror 115R passes the red beam and reflects the blue beam and the green beam at a certain angle, and the second dichroic mirror 115R passes the green beam and reflects the blue beam at a certain angle. The characteristics of mirror and dichroic mirror can change according to an arrangement of each colored light.

The optical modulator 130 modulates a beam emitted from the display light source 110 according to the control signal from the controller 170. The optical modulator 130 includes a plurality of micro-mirrors in parallel, and corresponds to a linear image that may be a vertical line or a horizontal line in one image frame to be displayed on the display screen 160. Namely, according to the control signal, the optical modulator 130 changes displacement of each micro-mirror corresponding to each pixel of the linear image and outputs the modulated lights with changed luminance of each pixel.

The number of micro-mirror is equal to or greater than the number of pixels consisting of the linear image. One micro-mirror may represent one pixel, or more than two adjacent micro-mirrors may represent one pixel. The modulated light is a line beam on where image data of linear image to be displayed on the display screen 160 (i.e., luminance of each pixel consisting of linear image) is reflected, and 0^{th} diffracted beam or +n-order diffracted beam, or −n-order diffracted beam. Where, n is natural number.

The driving circuit is further included to enable the displacement to be changed by providing the driving signal (e.g., drive voltage or current), which corresponds to the control signal from the controller 170, to each of micro-mirrors in the optical modulator 130.

The modulated light from the optical modulator 130 enters into the scanner 150 through the imaging optical system 140. The imaging optical system may include at least one lens, and deliver the modulated light by changing its multiplier based on the proportion of size of the optical modulator 130 to size of the scanner 150. Also, the imaging optical system 140 receives one of n^{th} diffracted beams from the optical modulator 130.

The scanner 150 projects the modulated light corresponding to the linear image by reflecting onto the display screen 160. By rotating the scanner 150 according to the control signal from the controller 170 to reflect the modulated light and to change the location where the modulated light is projected onto the display screen 160, a plurality of images are projected in a certain time period and then two or three dimensional images is displayed. The scanner 150 may be one of a polygon mirror or a rotating bar that can do one-directional rotation and a galvano mirror that can do bi-directional rotation.

The controller 170 generates the control signal to control the display light source 110, the optical modulator 130, and the scanner 150 according to the image data. The controller 170 divides image data of two or three dimensional image into data on a plurality of linear images, controls driving angle of scanner 150 for data on each linear image to reflect the modulated light from the optical modulator 130 onto the location in the display screen 160 corresponding to the linear image.

The optical modulator in one embodiment modulates a beam by controlling on/off of beam or using reflection/diffraction. The reflection/diffraction type modulator can be divided into an electrostatic type modulator and piezoelectric type modulator, and hereinafter, although the piezoelectric type modulator will be mainly described, but the same way can be applied to the electrostatic type modulator.

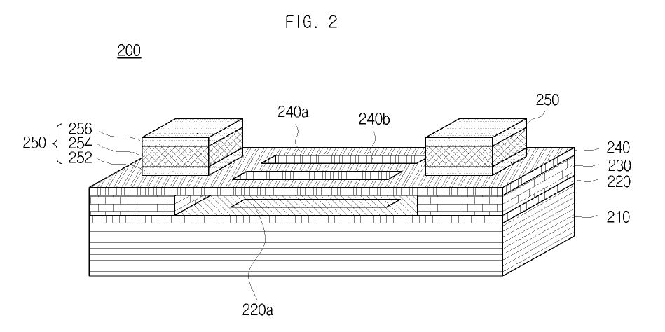

The micro-mirror included in the optical modulator having an open hole structure is shown in FIG. 2 to FIG. 4.

The micro-mirror 200 includes a substrate 210, an insulation layer 220, a ribbon structure 240, and piezoelectric elements 250.

The insulation layer 220 is deposited on the substrate 210, and there is a sacrificial layer 130 for supporting the ribbon structure 240 to be spaced from the insulation layer 220. The ribbon structure 240 creates interference in the incident light to provide optical modulation of signals. There are plural open holes 240b formed in the center portion of the ribbon structure 240. Although the open hole 240b is shown as rectangular shape elongated along a length direction of micro-mirror 200, but various shape such as circle or ellipse, and plural rectangular open holes may be arranged in parallel along a width direction of micro-mirror 200.

The piezoelectric elements 250 control the ribbon structure 240 to move vertically, according to the degree of up/down or left/right contraction or expansion generated by the difference in voltage between the upper and lower electrodes. Here, the reflective layer 220a is formed in correspondence with the holes 240b formed in the ribbon structure 240.

For example, in the case where the wavelength of a beam of light is λ, the first voltage is applied to the piezoelectric elements 250 for the gap between an upper reflective layer 240(a) formed on the ribbon structure 240 and a lower reflective layer 220(a) formed on the insulation layer 220 to be equal to (2l)λ/4 (wherein l is a natural number). Therefore, in the case of a O-order diffracted beam of light, the overall path length difference between the light reflected by the upper reflective layer 240(a) and the light reflected by the lower reflective layer 220(a) is equal to lλ, so that constructive interference occurs and the diffracted beam is rendered its maximum quantity of light. In the case of +1 or −1 order diffracted beam, however, the quantity of light is at its minimum value due to destructive interference.

Also, the second voltage is applied to the piezoelectric elements 250 for the gap between an upper reflective layer 240(a) formed on the ribbon structure 240 and a lower reflective layer 220(a) formed on the insulation layer 220 to be equal to (2l+1)λ/4 (wherein l is a natural number). Therefore, in the case of a 0-order diffracted beam of light, the overall path length difference between the light reflected by the upper reflective layer 240(a) and the light reflected by the lower reflective layer 220(a) is equal to (2l+1)λ/2, so that destructive interference occurs, and the diffracted beam is rendered its minimum quantity of light. In the case of +1 or −1 order diffracted beam, however, the quantity of light is at its maximum value due to constructive interference.

As a result of such interference, the optical modulator can load signals on the beams of light by controlling the quantity of the reflected or diffracted beam. While the foregoing describes the cases in which the gap between the ribbon structure 240 and the insulation layer 220 is (2n)λ/4 or (2n+1)λ/4. But by adjusting the gap, it is possible to control the luminance of light being interfered by reflection or diffraction of the incident light.

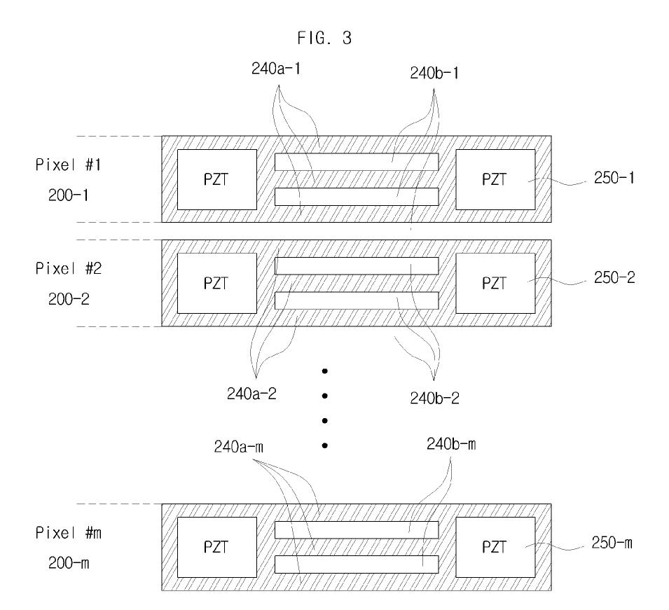

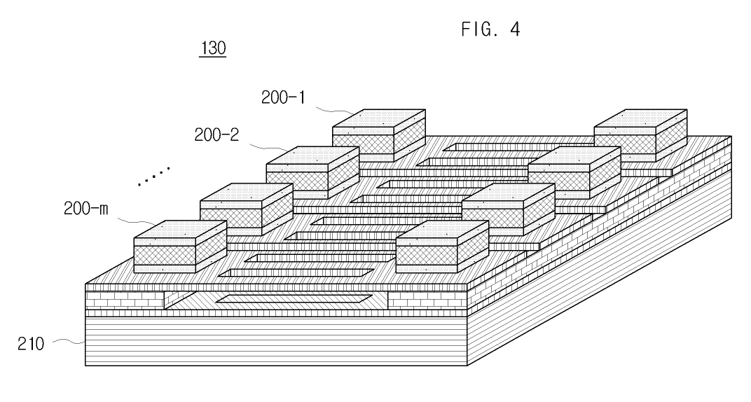

FIG. 3 is a plan view of an optical modulator containing a plurality of micro-mirrors illustrated in FIG. 2, and FIG. 4 is a perspective view of the optical modulator containing micro-mirrors illustrated in FIG. 2. In this embodiment, it is assumed that one micro-mirror will represent one pixel.

The optical modulator is composed of an m number of micro-mirrors 200-1, 200-2, . . . , 200-m, each responsible for pixel #1, pixel #2, . . . , pixel #m. The optical modulator deals with image information with respect to 1-dimensional images of vertical or horizontal scanning lines (Here, it is assumed that a vertical or horizontal scanning line consists of an m number of pixels.), while each micro-mirror 200-1, 200-2, . . . , 200-m deals with one pixel among the m pixels constituting the vertical or horizontal scanning line. Thus, the light reflected and/or diffracted by each micro-mirror is later projected by the scanner 150 as a 2-dimensional image on the display screen 160.

Although open hole type optical modulator having one micro-mirror with open hole representing one pixel is described as shown in FIG. 2 to FIG. 4, it is also possible for plural micro-mirrors to represent one pixel. In alternative, it is also possible for micro-mirror without open hole to use path length difference of the reflected light, which is caused by the height difference between odd-numbered micro-mirrors and even-numbered micro-mirrors. It would be understood by those who skilled in the art that various types of optical modulators can be applied to the embodiment.

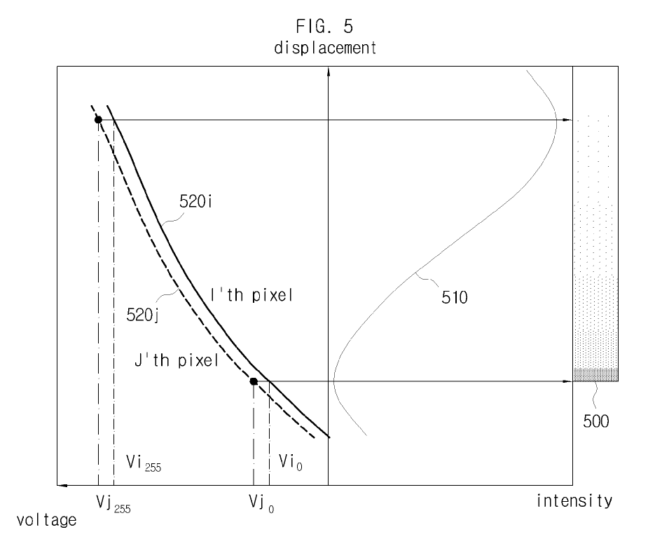

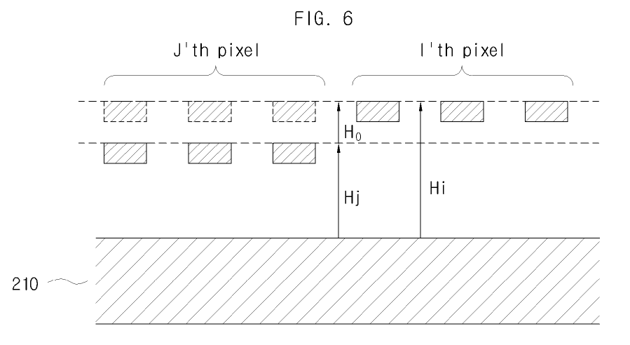

FIG. 5 shows a relation graph of voltage being applied to the optical modulator, the displacement of each micro-mirror therefore, and intensity (i.e., quantity of light) of modulated light, and FIG. 6 shows the displacement variation of micro-mirror responsible for each pixel.

Under same drive condition, when displacement (i.e., distance between the upper reflective layer and the lower reflective layer) of micro-mirror responsible for I^{th} pixel is Hi, and displacement of J^{th} pixel is Hj, then the displacement variation occurs (with reference to FIG. 6).

In this case, in order to make the luminosities of diffracted beam for I^{th} pixel and J^{th} pixel equal, a compensation voltage for making the displacements of micro-mirrors corresponding to each pixel equal should be applied to J^{th} pixel to further change the displacement of micro-mirror corresponding to J^{th} pixel by H0 (difference between Hi and Hj).

Referring to FIG. 5, 500 is quantity of light of diffracted beam, i.e., light intensity, and 510 is a quantity of light graph of diffracted beam according to the displacement of micro-mirror. 520i is a displacement graph of micro-mirror according to the drive voltage at I^{th} pixel, and 520j is a displacement graph of micro-mirror according to the drive voltage at J^{th} pixel.

When equal drive voltage are applied, there is difference in displacement of micro-mirrors of I^{th} pixel and J^{th} pixel, and the difference in displacement causes the difference in quantity of light. Thus in order to produce the diffracted beam having same quantity of light, it is required to apply different drive voltages to each pixel. Namely, voltages Vi₀˜-Vi₂₅₅ should be applied to I^{th} pixel, and voltages Vj₀˜Vj₂₅₅ should be applied to J^{th} pixel. In order to output diffracted beam having desired quantity of light according to the image data, voltages being applied differently to each pixel become the compensation voltage.

In order to decide these compensation voltages, it is needed to measure the quantity of light of diffracted beam at each pixel when a given voltage is applied.

Hereinafter an apparatus with monitoring light source for deciding the compensation voltage to compensate the displacement variation of each pixel by measuring the quantity of light of diffracted beam and method thereof will be described.

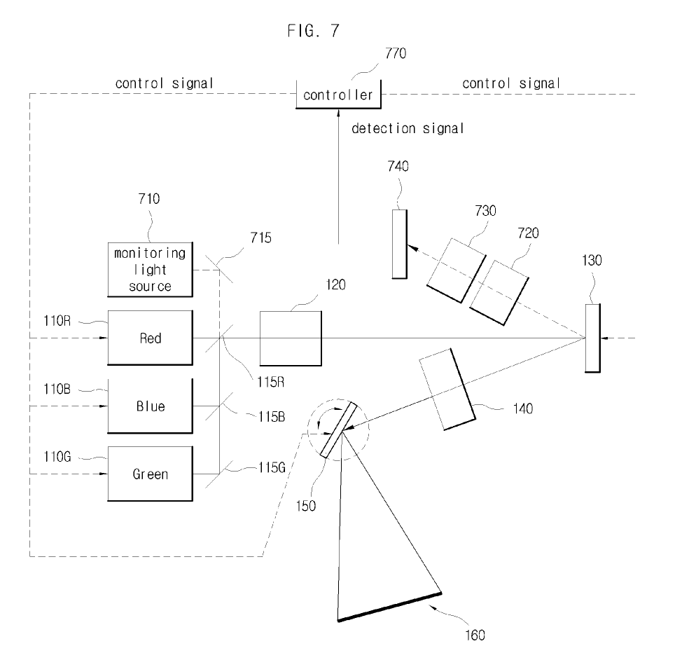

FIG. 7 shows a display apparatus using the monitoring light source according to one embodiment of the present invention.

Red light source 110R, blue light source 110B, green light source 110G, mirror 115G, the first dichroic mirror 115R, the second dichroic mirror 115B, illumination optical system 120, optical modulator 130, imaging optical system 140, scanner 150, display screen 160, monitoring light source 710, mirror 715, wavelength selection filter 720, small optical system 730, optical detector 740, and controller 170 are shown. Some elements perform same function as shown in FIG. 1 so duplicated description will be omitted here and distinguished features will be mainly described. Here, red light source 110R, blue light source 110B, green light source 110G corresponds to the display light source, and although the implementation of color image is assumed in this embodiment, however, it is apparent that the present invention would not be limited to this embodiment.

Unlike emitting of display light source (e.g., red light source 110R, blue light source 110B, green light source 110G), the monitoring light source 710 emits monitoring beam for measuring displacement variation of micro-mirror in the optical modulator that corresponds to each pixel of linear image.

The illumination optical system 120 may further include a device for enabling the monitoring beam to progress along beam path of the optical modulator 130. This device may include the mirror 715 for reflecting the monitoring beam from the monitoring light source 710, and the first dichroic mirror 115R for reflecting the monitoring beam that is being reflected by the mirror 715 to enter into the illumination optical system 120.

The optical modulator 130 modulates the incident monitoring beam and display beam to produce n^{th}-order diffracted beams (n is natural number). It is assumed that a^{th}-order diffracted beam is selected for monitoring from n^{th} order diffracted beams of the monitoring beam and b^{th}-order diffracted beam is selected for displaying from n^{th} order diffracted beams of the display beam. Where, a and b are integer. In this case, each beam path of a^{th}-order diffracted beam and b^{th}-order diffracted beam may be different from each other, and the beam paths of diffracted beams are separated spatially as shown in FIG. 7, so it is possible to measure the quantity of light of monitoring beam by locating the wavelength selection filter 720 and the optical detector 740 on the beam path through where the monitoring beam progresses.

The wavelength selection filter 720, the small optical system 730, and the optical detector 740 locates on the beam path of the diffracted monitoring beam from the optical modulator 130.

The wavelength selection filter 720 passes a diffracted beam with wavelength corresponding to the monitoring beam, and blocks diffracted beams with other wavelengths. Thus, diffracted display beam cannot progress due to the wavelength selection filter 720, and the diffracted monitoring beam can progress.

And the small optical system 730 adjusts the multiplier for the diffracted monitoring beam to be suitable for the size of optical detector 740.

The optical detector 740 receives the diffracted monitoring beam, and converts a quantity of light of the diffracted beam, i.e., intensity of light, into a detection signal that is an electrical signal to output to the controller 770. The optical detector 740 may be one of a photo detector with one sensor and a segmented detector with plural unit sensors.

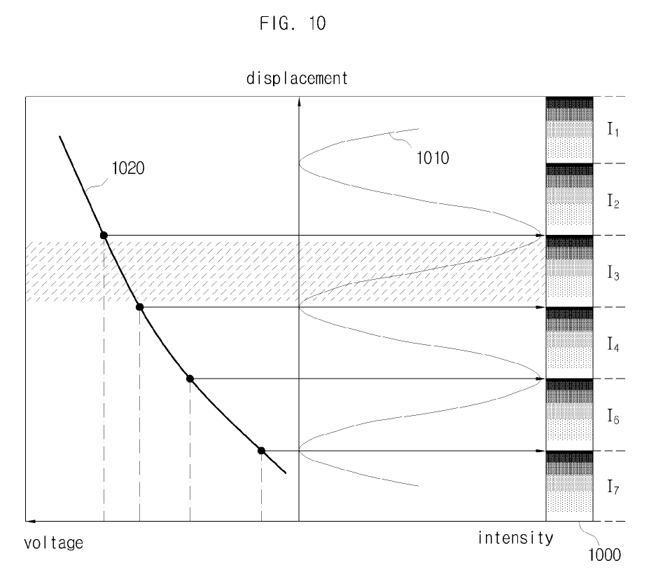

The controller 770 measures quantity of light of the diffracted monitoring beam by using the detection signal from the optical detector 740, and calculates the displacement of micro-mirror in the optical modulator by using 510 graph in FIG. 5. And in order to output the diffracted monitoring beam, the controller compares the drive voltage being applied to the optical modulator 130 and the calculated displacement of the micro-mirror, and decides the compensation voltage. The compensation voltage being decided for each pixel can be stored in a lookup table (LUT) in memory, and then the compensation voltage will be referred whenever producing the control signal to the optical modulator according to the image data. The control signal from the controller 770 and the detection signal from the optical detector will be described with reference to FIG. 10.

As the optical modulator 130 includes a plurality of micro-mirrors, it is possible to measure the displacement of micro-mirror responsible for one pixel at one time or the displacement of micro-mirror responsible for plural pixels at one time.

Here, the monitoring beam being emitted from the monitoring light source 710 has different wavelength from the colored light being emitted from the display light sources. This is for the case that when a^{th}-order diffracted monitoring beam and n^{th}-order diffracted display beam have similar beam path, the wavelength filter 720 can distinguish the diffracted monitoring beam from the diffracted display beam to selectively pass the diffracted monitoring beam.

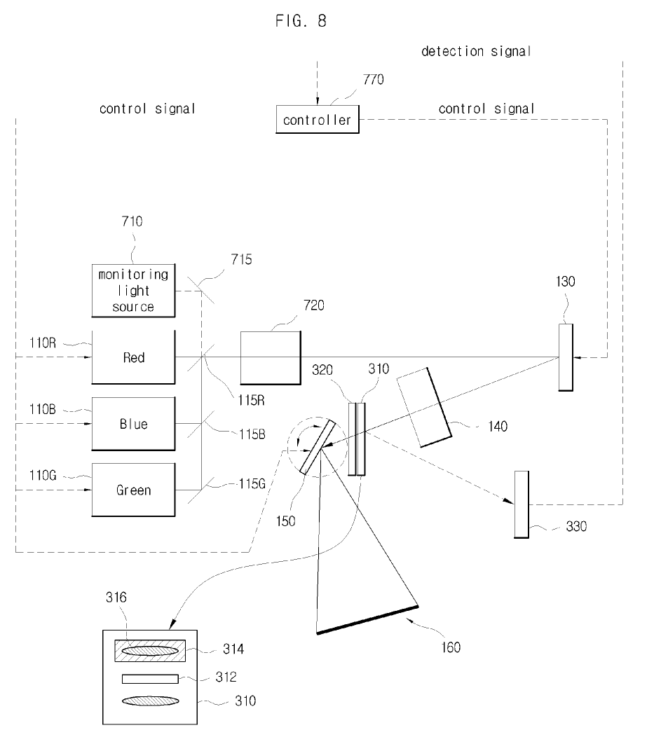

FIG. 8 shows a display apparatus using a monitoring light source according to another embodiment of the present invention.

Red light source 110R, blue light source 110B, green light source 110G, mirror 115G, the first dichroic mirror 115R, the second dichroic mirror 115B, illumination optical system 120, optical modulator 130, imaging optical system 140, scanner 150, display screen 160, monitoring light source 710, mirror 715, spatial separation filter 310, wavelength selection filter 320, optical detector 330, and a controller 770 are shown. Some elements perform same function as shown in FIG. 1 or FIG. 7 so duplicated description will be omitted here and distinguished features will be mainly described.

It is assumed that a^{th}-order diffracted beam is selected for monitoring from n^{th} order diffracted beams of the monitoring beam and b^{th}-order diffracted beam is selected for displaying from n^{th} order diffracted beams of the display beam. Where, a and b are integer.

In this case, the diffracted monitoring beam progresses through the imaging optical system 140 and in the beam path similar to the diffracted display beam.

The spatial separation filter 310 is arranged on the beam path to pass the diffracted display beam and to reflect the diffracted monitoring beam toward the optical detector 330. The spatial separation filter 310 has a hole 312 formed on a portion corresponding to the beam path of diffracted display beam so the diffracted display beam can pass through. And the spatial separation filter 310 has a mirror 314 formed on a portion corresponding to the beam path of diffracted monitoring beam so the diffracted beam 316 of monitoring beam cannot pass through and then is reflected toward the optical detector 330. The optical detector 330 receives the diffracted monitoring beam of which beam path was changed by the spatial separation filter 310, and converts a quantity of light of the diffracted beam, i.e., intensity of light, into a detection signal that is an electrical signal to output to the controller 770.

The wavelength selection filter 320 for passing a light having same wavelength of the diffracted display beam and blocking other lights having different wavelength may be further arranged in the back of spatial separation filter 310. If some of diffracted monitoring beam passes through the hole 312 in the spatial separation filter 310, it will be blocked by the wavelength selection filter 320.

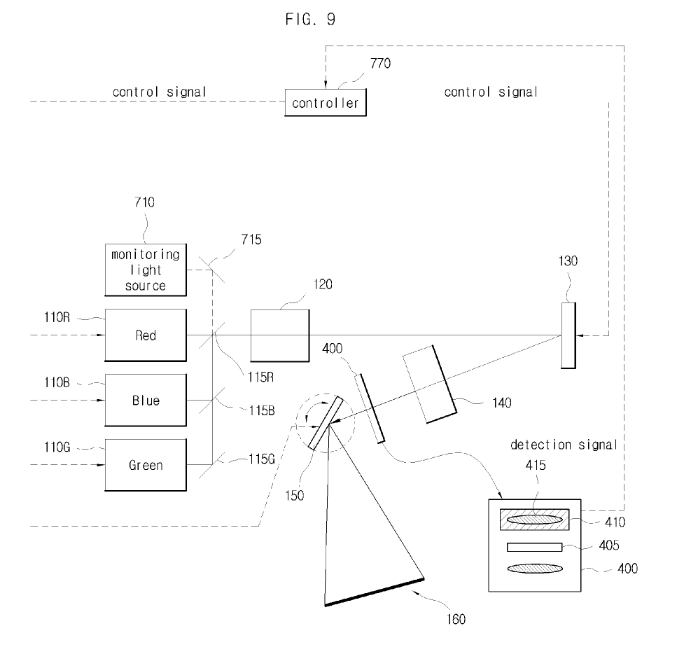

FIG. 9 shows a display apparatus using a monitoring light source according to still another embodiment of the present invention.

Red light source 110R, blue light source 110B, green light source 110G, mirror 115G, the first dichroic mirror 115R, the second dichroic mirror 115B, illumination optical system 120, optical modulator 130, imaging optical system 140, scanner 150, display screen 160, monitoring light source 710, mirror 715, spatial separation filter 400, and a controller 770 are shown. Some elements perform same function as shown in FIG. 1 or FIG. 7 so duplicated description will be omitted here and distinguished features will be mainly described.

It is assumed that a^{th}-order diffracted beam is selected for monitoring from n^{th} order diffracted beams of the monitoring beam and b^{th}-order diffracted beam is selected for displaying from n^{th} order diffracted beams of the display beam. Where, a and b are integer.

In this case, the diffracted monitoring beam progresses through the imaging optical system 140 and in the beam path similar to the diffracted display beam.

The spatial separation filter 400 is arranged on the beam path to pass the diffracted display beam. The spatial separation filter 400 has a hole 312 formed on a portion corresponding to the beam path of diffracted display beam so the diffracted display beam can pass through. And the optical detector 410 is arranged on a location corresponding to the beam path of diffracted beam 415 of monitoring beam to generate the detection signal according to the quantity of light of the diffracted monitoring beam and output to the controller 770.

The wavelength selection filter (not shown) for passing a light having same wavelength of the diffracted display beam and blocking other lights having different wavelength may be further arranged in the back of spatial separation filter 400. If some of diffracted monitoring beam passes through the hole 415 in the spatial separation filter 400, it will be blocked by the wavelength selection filter.

FIG. 10 shows a relation graph of voltage being applied to the optical modulator, the displacement of each micro-mirror therefore, and intensity (i.e., quantity of light) of modulated light according to one embodiment of the present invention.

1000 is a quantity of light of monitoring beam, i.e., light intensity, and 1010 is a quantity of light of the diffracted monitoring beam according to the displacement of micro-mirror. 1020 is a displacement graph of micro-mirror according to the drive voltage.

The diffracted beam that enters from the monitoring light source and is modulated by the optical modulator has a phase according to its n^{th}-order diffraction, and its maximum and minimum quantity of light are repeated at ¼ cycle of wavelength of monitoring beam according to displacement of each micro-mirror in the optical modulator (with reference to 1010).

When the wavelength and the incident angle are known, it is possible to know how the displacement of each micro-mirror changes according to the applied drive voltage by the change in quantity of light of the diffracted beam in response to the drive voltage being applied to each micro-mirror in the optical modulator.

By periodically or non-periodically measuring the displacement in response to the drive voltage applied to each micro-mirror by working the monitoring light source, acquiring the relationship of drive voltage and displacement, and compensating the image data being inputted, it is possible to compensate the variation of drive displacement of each micro-mirror.

Since the change in quantity of light according to the displacement of micro-mirror as shown in 1010, the absolute displacement cannot be obtained, however, the correct displacement difference within a certain range such as the dashed region can be obtained.

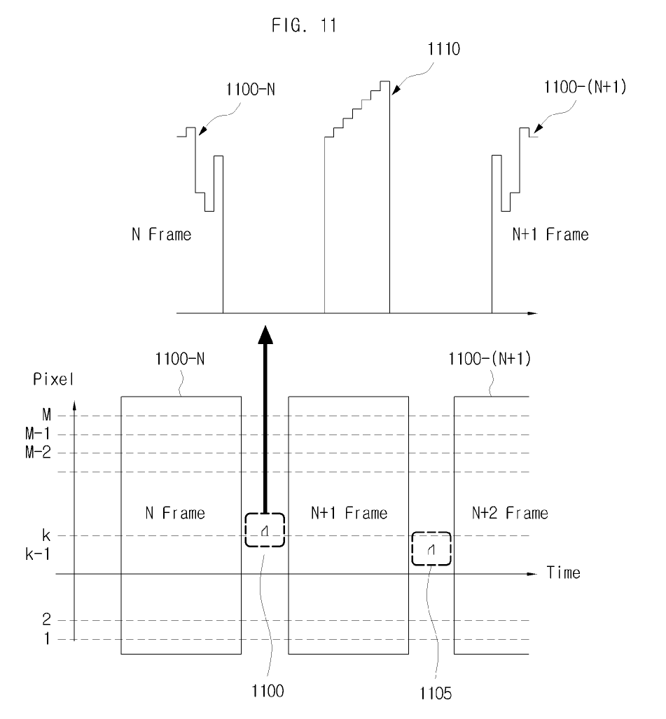

In embodiment, it is possible to time-divisionally control the monitoring light source and the display light source against being entered together into the optical detector. Namely, by distinguishing the time for displaying and monitoring, the display light source is turn on and the monitoring light source is turn off for a time for a portion of time within a certain period of time, and the display light source is turn off and the monitoring light source is turn on for the rest of time within the period of time. Referring to FIG. 11, in case of time-divisionally controlling, an output timing of drive signal for measuring variation of displacement of micro-mirror is shown.

The drive signal 1100 for measuring drive displacement of micro-mirror corresponding to the k^{th} pixel of the optical modulator during a blank time between the N^{th} image frame 1100-N and N+1^{th} image frame 1100-(N+1) is produced. The pixel to be measured may be changed at every blank time (with reference to 1105). Namely, it is possible to measure and compensate the drive displacement for each pixel at every blank time.

And the wavelength of monitoring beam may be out of visible ray. In this case, the monitoring beam does not affect display so it is possible to measure the drive displacement of each pixel without time divisionally controlling the monitoring light source and the display light source.

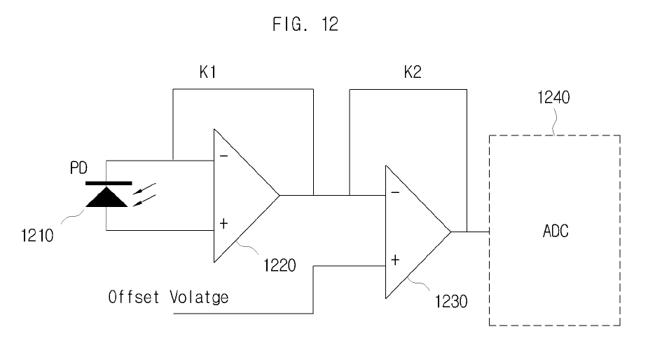

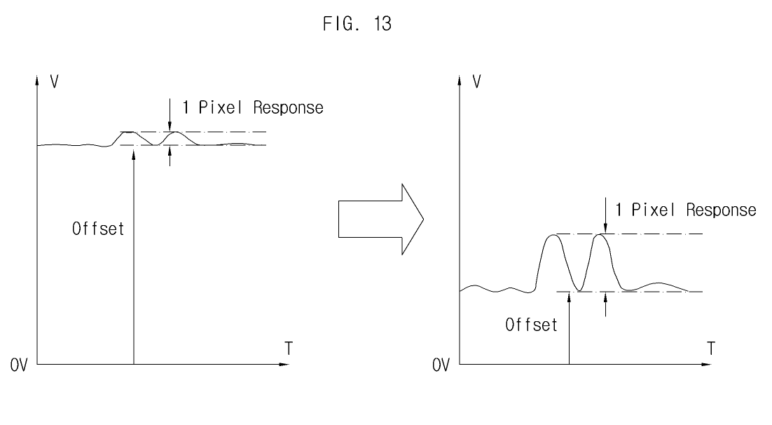

FIG. 12 shows a circuit diagram of optical detector according to one embodiment of the present invention, and FIG. 13 illustrates the quantity of light of measured diffracted monitoring beam.

Referring to FIG. 12, the optical detector includes optical detecting part 1210, measuring part (including current-voltage amplifying part 1220 and offset adjusting part 1230), and AD converting part 1240.

The optical detecting part 1210 detects the quantities of light of diffracted monitoring beam. This is represented in current being outputted from the optical detecting part 1210. The current-voltage amplifying part 1220 converts voltage from the optical detecting part 1210 into voltage.

The conversion into voltage is shown at the left in FIG. 13. The optical detecting part 1210 detects quantity of light of diffracted monitoring beam so the quantities of light for micro-mirrors drive other than the micro-mirror corresponding to the pixel to where the signal for measurement is applied can be measured. Even if pixels other than the pixel to where the drive signal for measurement is applied is set to minimum luminance, there should be a measured value so that value can be offset.

In order to measure the change in quantity of light according to the drive signal for measurement at one pixel, it is needed to amplify the output K1 of current-voltage amplifying part 1220, but it is amplified after removing some portion of offset rather than directly amplifying because of offset.

The adjustment of offset can be achieved by inputting an offset voltage and an output from the current-voltage amplifying part 1220 to a positive terminal and a negative terminal of offset-adjusting end 1230 that consists of an OP amp respectively to remove the offset corresponding to the offset voltage. The offset adjusting end 1230 is OP amp, so it can detect the change in quantity of light at one pixel according to the drive signal for measurement by setting a proper gain K2 (referring the right in FIG. 13).

Although certain embodiments of the present invention have been described, it shall be evident to anyone of ordinary skill in the art that there can be a large number of permutations or modifications are possible without departing from the technical ideas of the present invention, which shall be only defined by the appended claims.

What is claimed is:

1. A display apparatus, comprising:
a display light source, emitting a display beam;
a monitoring light source, emitting a monitoring beam;
an optical modulator, modulating the display beam and the monitoring beam to output a diffracted display beam and a diffracted monitoring beam;
a scanner, scanning the diffracted display beam onto a display screen;
an optical detector, receiving the diffracted monitoring beam and producing a detection signal corresponding to a quantity of light of the diffracted monitoring beam; and
a controller, producing a control signal for controlling the optical signal according to an image signal, deciding a compensation value on receiving the detection signal, and producing a control signal to where that the compensation value is applied when modulating the display beam.

2. The apparatus in claim 1, in which the monitoring beam has a wavelength different from display beam.

3. The apparatus in claim 1, in which the monitoring beam has a wavelength out of visible ray.

4. The apparatus in claim 3, in which the monitoring beam is an infrared.

5. The apparatus in claim 1, in which the optical detector comprises a photo detector.

6. The apparatus in claim 1, in which the optical detector comprises a plurality of unit sensors.

7. The apparatus in claim 1, in which the optical modulator produces a n^{th} order diffracted beam (n is equal to or greater than 0),
wherein the optical detector receives an ath order diffracted beam of the diffracted monitoring beam, and the scanner receives a bth order diffracted beam of the diffracted display beam, wherein a and b are integer.

8. The apparatus in claim 1 further comprising a wavelength selection filter, being located on a beam path of the diffracted monitoring beam and passing the diffracted monitoring beam,
wherein the optical detector arranges the wavelength selection filter at a location corresponding to a beam path of the diffracted monitoring beam.

9. The apparatus in claim 1, in which the optical modulator produces n^{th} order diffracted beams (n is natural number),
wherein the optical modulator further comprises
an imaging optical system, progressing one diffracted beam among n^{th} order diffracted beams from the optical modulator to the scanner; and
a spatial separation filter, being located between the imaging optical system and the scanner, blocking the diffracted monitoring beam, and passing the diffracted display beam.

10. The apparatus in claim 9, in which the spatial separation filter comprises a hole being formed on location corresponding to a beam path of the diffracted display beam.

11. The apparatus in claim 9, in which the spatial separation filter comprises a mirror at a location corresponding to a beam path of the diffracted monitoring beam so changes the beam path of the diffracted monitoring beam to be entered into the optical detector.

12. The apparatus in claim 9, in which the spatial separation filter arranges the optical detector at a location corresponding to a beam path of the diffracted monitoring beam.

13. The apparatus in claim 1, in which the controller controls the monitoring light source and the display light source time-divisionally.
